(19) United States
(12) Patent Application Publication
(10) Pub. No.: US 2025/0062518 A1
(43) Pub. Date: Feb. 20, 2025

(54) Scalable array of distributed elongated element and method of forming the same

(71) Applicant: Oleksandr Chernyashevskyy, White Plains, NY (US)

(72) Inventor: Oleksandr Chernyashevskyy, White Plains, NY (US)

(21) Appl. No.: 18/928,052

(22) Filed: Oct. 27, 2024

Related U.S. Application Data
(63) Continuation of application No. 29/875,561, filed on May 6, 2023.
(63) Continuation of application No. 63/594,653, filed on Oct. 31, 2023.

(51) Int. Cl. H01P 3/00; H01P 5/18

(52) U.S. Cl. CPC H01P 3/003; H01P 5/184

(57) ABSTRACT

The various embodiments described herein include an arrays of distributed elongated element (DEE) and/or element having coplanar waveguide (CPW) architecture and methods of configuring, forming, assembling and operating of said arrays. One implementation utilizes the scalable array of DEE and/or CPW element having a plurality of the DEE and/or CPW disposed over a principal surface of a shaped piece of dielectric material. The plurality of the DEE and/or CPW element arranged thereon in such a manner that the DEE do not cross each other, and each DEE separated from an adjacent DEE by an elongated respective gap, wherein a length of DEE and elongated gap may be essentially the same.

### CROSS REFERENCE TO RELATED APPLICATION

This application claims the benefit of U.S. Provisional Application Ser. No. 63/594,653 filed Oct. 31, 2023 under 35 U.S.C. § 119 (e), which application is a continuation-in-part of, and claims benefit of and priority to, U.S. design patent application Ser. No. 29/875,561 filed May 5, 2023, each said application hereby incorporated herein by reference in its entirety.

### TECHNICAL FIELD

This disclosure relates generally to an arrays of distributed elongated element (DEE) and more specifically to design and methods of forming of scalable arrays of DEE and/or element having coplanar waveguide (CPW) architecture.

### SUMMARY OF THE INVENTION

According to one aspect of the present invention, there is provided a scalable array of a distributed elongated element (DEE) comprising a plurality of the DEE disposed over at least of portion of one or more principal surface of shaped piece of dielectric material. The plurality of DEE arranged thereon in such a manner that DEE do not cross each other, and the adjacent DEE are separated by a respective gap.

According to another aspect of the present invention, there is provided a scalable array of a coplanar waveguide (CPW) element comprising a plurality of the CPW element disposed over at least of portion of one or more principal surface of shaped piece of dielectric material. The plurality of the CPW element arranged thereon in such a manner that CPW element do not cross each other, and the adjacent CPW element configured to have common ground electrode in form of a respective elongated ground stripe.

According to yet another aspect of the present invention, there is provided a method of forming of the scalable array of a coplanar waveguide (CPW) element, the method comprising steps of providing a shaped piece of dielectric material having one or more principal surface, disposing a plurality of the CPW element over at least a portion of one or more principal surface of the shaped piece of dielectric material in such a manner that CPW element do not cross each other, forming an adjacent CPW element to have common ground plane in form of a respective elongated ground stripe.

### BRIEF DESCRIPTION OF DRAWINGS

The drawings do not illustrate all possible embodiments. The sizes and relative positions of elements in the drawings are not necessarily drawn to scale. Further, the particular shapes of the elements as drawn are not intended to convey any information regarding the actual shape of the particular elements because present specification may be practiced without such details. Furthermore, schematic illustrations may not reflect fabrication technique limitations which may cause the real structures, parts and elements to look not so perfect. The conductor backing electrode, if used, is not shown.

FIG. 1 is a plan view of a signal and ground inlay of a rectangular shaped array of CPW element.

FIG. 2 is a plan view of a signal and ground inlay of a “elbow” shaped array of DEE.

FIG. 3 is a plan view of a signal and ground inlay of an array of “pi” shaped DEE.

FIG. 4,5 are a plan view of a signal and ground plate inlay of a “circularly” shaped array of DEE.

FIG. 6,7 is a plan view of a signal and ground inlay of a rectangular shaped array of DEE.

FIG. 8 is a plan view of a signal and ground inlay of a “spiral” shaped array of DEE.

FIG. 9a, 9b is a cross-sectional view taken perpendicular to the direction of signal lines of the DEE formed over concave and convex principal surface of a shaped piece of dielectric material.

### DETAILED DESCRIPTION OF THE INVENTION

Present disclosure includes a variety of aspects, which may be combined in different ways. Throughout this specification an embodiments of the disclosure herein may be configured as an apparatus, system, method, or any combination thereof. However it should be understood that select embodiments may be combined in any manner and in any number to create additional embodiments. A discussion of well known in the art elements, structures and steps is not provided herein, because they do not facilitate a better understanding of the present invention. A discussion of elements, structures and steps well known in the art is not provided herein, because they do not facilitate/help a better understanding of the present invention.

As used herein, the term “shaped piece of dielectric material” may be formed from a crystalline and/or single crystal material including but not limited to silicon, sapphire, silicon-on-insulator (SOI), III-V material, quartz, monocrystallite optical material and the like and may have a flat, concave (FIG. 9a), convex (FIG. 9b), cylindrical, or any free form shapes the principal surface.

In other implementations, the “shaped piece of dielectric material” may be formed from non-crystalline material including but not limited to a various paper or cloths impregnated with resin/epoxy composite material, plastics, amorphous optical material, fused silica, quartz and the like. As a common feature, shaped piece of dielectric material may be provided as a printed circuit boards (PCBs), including but not limited to a biodegradable and/or bioresorbable PCBs, rigid PCBs, flexible PCBs, optical components and the like.

For various embodiments the shaped piece of dielectric material may contain a RF/microwave energy dissipative/absorbing material selected from a discontinuous dissipative layers/films, dissipative particles and dissipative powders and any combination thereof.

In general, any material, whether now known or later developed, that has sufficiently good dielectric properties and potentiality to implement fabrication and processing techniques to exceed a possible negative effects and/or disadvantages of various flaws/imperfections may serve as the shaped piece of dielectric material.

As used herein, the term “Distributed Elongated Element” (DEE) refers to the microwave and/or RF distributed element, structure, component, part, or the like been disposed over one or more principal surface of shaped piece of dielectric material.

As used herein, the terms such as “DEE”, may be used interchangeably with the terms selected from group of terms comprising “signal line”, “signal path”, “conductor strip”, “elongated thin film”, “center conductor line structure”, “bias line”, “DC power line” and any combination of this as those skilled in the relevant art will recognize.

In various embodiments, a multiple DEE may be disposed over a surface of a shaped piece of dielectric material to form an “array of DEE”.

In various embodiments, one or more DEE may be selected from a group of structure/element comprising a coplanar waveguide (CPW) having Standard, CBCPW, coplanar stripes, embedded coplanar stripes architecture, CPW with finite dielectric thickness, CPW with finite width ground planes architecture, CPW with a cover shield, conductor-backed CPW with or without a cover shield, micro-strip line having standard, suspended, inverted, in box, trapped inverted architecture, asymmetric CPW, asymmetric CPW with finite dielectric thickness, coplanar stripes, coplanar waveguide resonator (CPWR), stripline resonator, microstrip resonator, coplanar strip resonator, puck resonator, slotline resonator, hairpin resonator, conductor-backed CPW, multilayered CPW, slotline having Standard, Antipodal, Bilateral Architecture, Substrate-integrated Waveguide, imageline stripline, “linear”/planar inductor, grounding stripe and related structures whether now known or later developed and any combination thereof.

In another embodiments, the principal surface of the shaped piece of dielectric material could have different shapes and/or forms as shown in FIG. 9a and FIG. 9a.

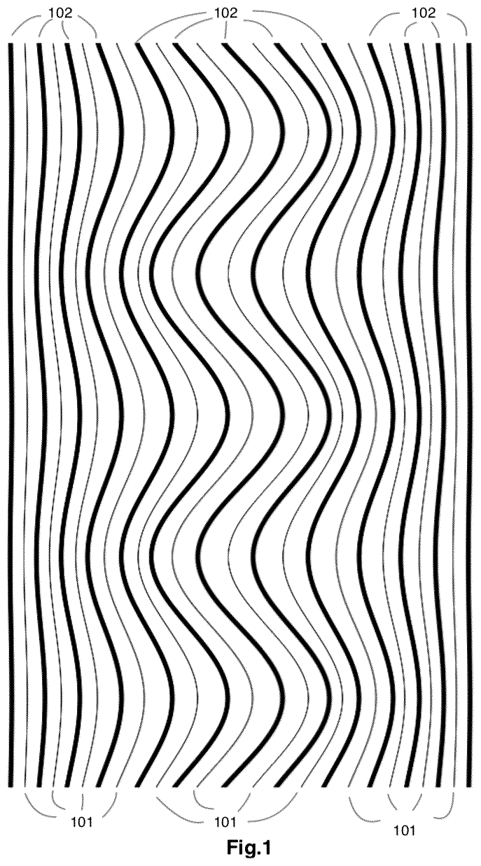

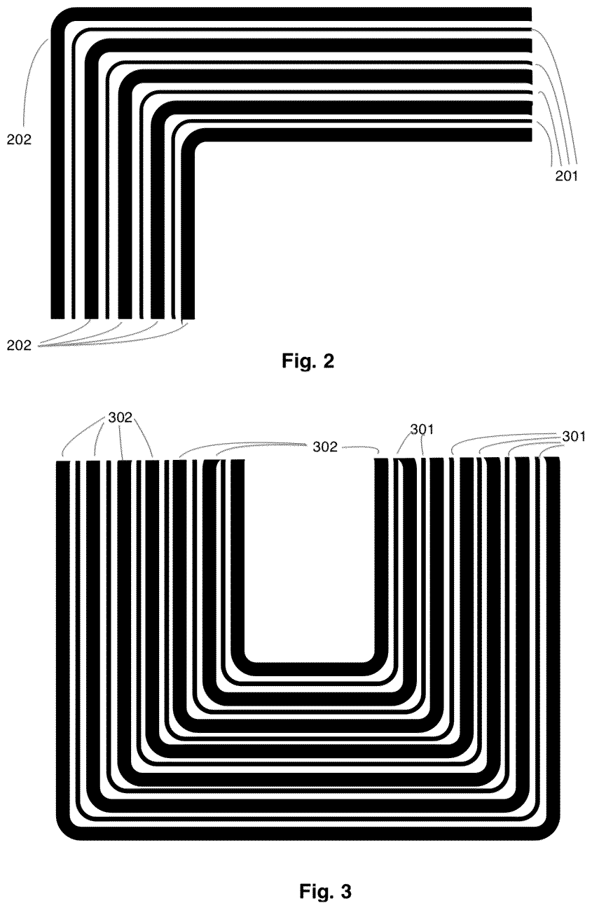

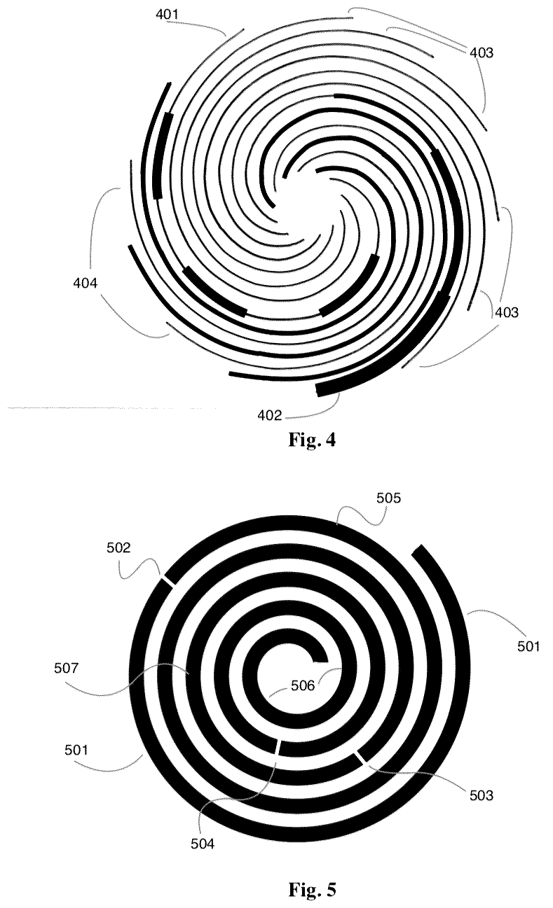

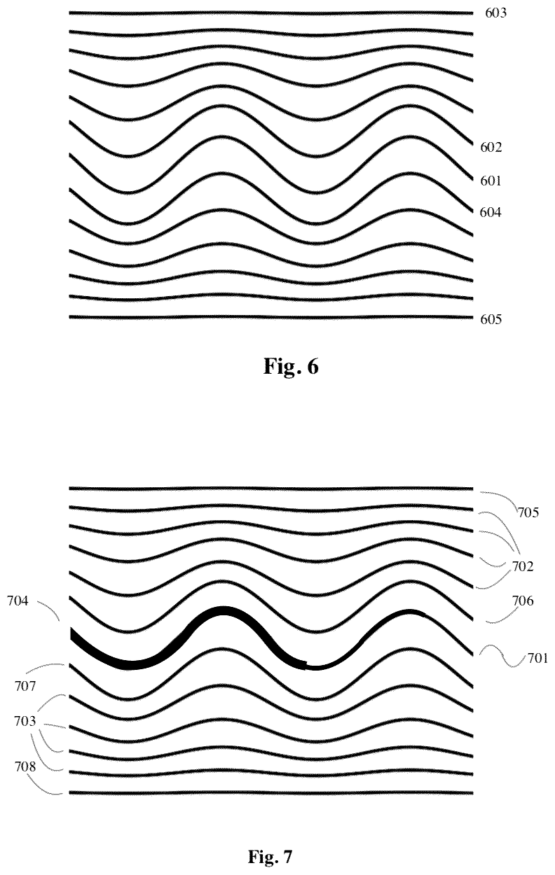

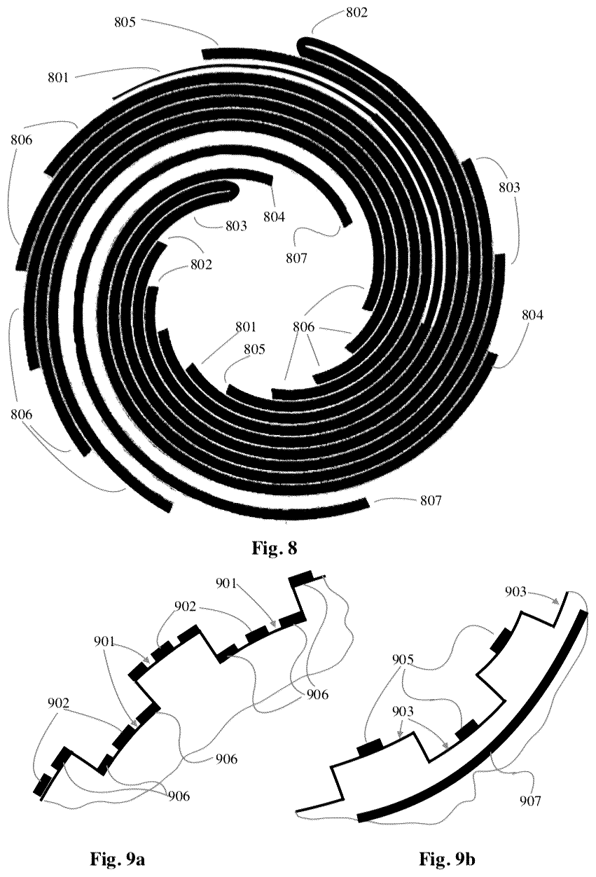

In various embodiments, a DEE and/or CPW element configured in an arrays as shown in FIG. 1-9 may have different shapes, forms, dimensions and layouts.

In yet another embodiment a width of DEE and/or CPW element, a separating elongated gap, and elongated ground plane may have different length and/or width due to considerations of an array of DEE geometry and/or characteristics.

In various embodiments at least one or more DEE and/or CPW element may be selected from a group of microwave signal path 807, impedance matching element 402, power/signal divider, electric power/bias path/line, stepped impedance low pass filter element 401, inductor, impedance tuning element, attenuator, distributed step discontinuity element and the like and any combination thereof.

In various embodiments, a one or more DEE and/or CPW element besides providing a path to a signal may be configured as a DC electric power and/or bias path.

In another embodiments an array of a DEE and/or CPW element may be configured and selected form group comprising signal line, resonator, delay line, phase shifter, attenuator, filter structure and the like or any combination thereof.

In various embodiments at least a portion of an array of DEE and/or CPW element may be configured as low-pass filter, high-pass filter, band-pass filter, band-stop filter, comb filter, hair-pin filter and the like or any combination thereof.

In yet another embodiments a multiple combinations of different sequences of DEE and/or CPW on a principal surface of shaped piece of dielectric material may improve desirable signal coupling between DEE and/or group of DEE by positioning an adjacent structure closer to each other.

In various embodiments at least portion a scalable array of DEE and/or CPW element may be formed from multiple DEE operatively/communicatively coupled in series, i.e. configured in form of cascade of the element 501, 505, 507 (FIG. 5). For instance element 501 may be communicatively coupled to 505 by lumped element i.g. a gap or finger capacitor.

In various embodiments a “crosstalk” or inevitable unwanted signal coupling between an array element may be reduced below tolerable level by sandwiching/positioning one or more “victim” i.e. “sensitive” DEE and/or CPW element, between less “aggressive” structures, whether now known or later developed, as described in example below.

In yet another embodiment one or more DEE and/or CPW element may be disposed over elongated elevated 905 and/or recessed 904 portions of substrate to thereby provide an array code free of unwanted crosstalk interactions.

In various embodiments, the DEE as described above may be fabricated using any suitable fabrication techniques, whether now known or later developed.

In various embodiments a material that may be used in the fabrication of DEE and elongated ground structures, stripes, planes, finger, films may be selected from group comprising superconductor, high temperature superconductor, non-superconducting material, and any combination thereof. Generally speaking, the DEE fabricated from superconducting material may not necessarily be in superconducting state and/or acting as a superconductor at all times in all embodiments of the present disclosure.

In yet another embodiments at least a portion of an array of DEE and/or CPW elements may be fabricated according to an environment friendly transient technology, whether now known or later developed. A capability of at least partially disintegrating, dissolving or vanishing after pre-selected stable period of operation of the array may be applied.

### Select Example

Example 1 provides a scalable up and down array of DEE and/or CPW element disposed over one or more principal surface of shaped piece of dielectric material having a wide variety of different geometries, shape and architecture selected to suit the needs of a particular application. While the arrays are shown, by way of illustration, in FIG. 1-9 to enclose substantially square/rectangular or circular areas, in various embodiments the array of DEE and/or CPW element can take any suitable free form shapes, such as e.g. substantially triangular, octagonal, wavy, oval or like.

Example 2 provides an array of DEE wherein one or more elongated element having similar, identical and/or different characteristics/parameters selected to suit the needs of a particular application.

Example 3 provides an array of DEE and/or CPW element wherein a shape of one or more signal element/line and respective elongated gap having non-uniform dimensions, and/or different shapes and layouts selected to suit the needs of a particular application.

Example 4 provides an array having desired number of the DEE and/or CPW element selected from a group comprising resonator, directional and/or bi-directional coupler, microwave line, phase shifter line, delay line, drive line, bias line and the like, and any combination thereof.

Example 5 provides the array according to Example 4, having desired number of the DEE and/or CPW elements with different physical lengths, electrical lengths, resonant frequencies, quality factor, impedance, geometry, shape, and any combination thereof. For instance, scalable array may be build with M CPWR, K delay line, L filter element where M, K and L are natural numbers. A shape of array of DEE and/or CPW elements is merely exemplary and is not restricted to be rectangular and been disposed over plain substrate.

Example 6 provides an array of DEE that includes one or more an impedance matching element 402, 801 having microstrip architecture.

Example 7 provides an array of DEE that includes one or more a high impedance resonator 601-605, 403 having microstrip architecture.

Example 8 provides an array of DEE that includes one or more a conductor backed step impedance low pass filter 401 (FIG. 4) having microstrip architecture.

Example 9 provides an array of DEE that includes one or more impedance matching element 402, 701, 704.

Example 10 provides an array of DEE and/or CPW element wherein one or more distributed elongated element configured as a resonator may be disposed between an “aggressor” and a “victim” element. Main advantage of this pattern is that the effect of crosstalk from “aggressor” distributed element structure to “victim” structure may be reduced/suppressed. Such a strategy may improve a scalability of the array and/or increase component density.

Example 11 provides an array of DEE and/or CPW element wherein one or more element disposed over recessed 904 and/or elevated 905 portion of the shaped piece of dielectric material surface topology. It may reduce side crosstalk below tolerable levels.

Example 12 provides an array of coplanar waveguide resonator and/or delay line (FIG. 1-3).

Example 13 provides an array of DEE and/or CPW element formed as a counter-clockwise “bended”/“winded” group of the elements (FIG. 4,5,8).

Example 14 provides an array of DEE and/or CPW element formed as a clockwise “bended/winded” group of the elements.

Example 15 provides a DEE array having galvanically coupled proximal and/or distal end of one or more element to form U shaped “hairpin resonator” 802, 803, 804, 805. An RF/microwave filter having desired bandpass may be formed from multiple resonators having “hairpin” architecture.

Example 16 provides the array of DEE and/or CPW element according to any one of Examples 1-13 wherein at least a portion of the array may be formed over concave 903 and/or convex 901 principal surface of shaped piece of dielectric material.

Example 17 provides the array of DEE and/or CPW element according to any one of Examples 1-14 wherein at least a portion of the array formed over shaped piece of dielectric material wherein the dielectric material is a composite sintered body in which conductive particles are dispersed in an insulating material. For example the conductive particles are a mixed conductive particles wherein plural kinds of conductive particles having different average particle dimension and/or material electrical conductivity are mixed. Main advantage of this pattern is that the effect of crosstalk from an “aggressor” distributed element to a “victim” element may be suppressed.

Example 18 provides the array of DEE and/or CPW element according to any one of Examples 1-14 wherein another technique for unwanted crosstalk energy trapping would be a deposition of a thin film of radiant energy absorbing material over the at least a portion of the array area. Main advantage of this pattern is that an impact of crosstalk from “aggressor” distributed element structure to “victim” element may be suppressed.

Example 19 provides an array of DEE comprising multiple DEE communicatively coupled by lumped element. For instance array on FIG. 5 comprise resonator having microstrip architecture wherein signal line 501, 505, 507 are communicatively coupled in series by a “gap” capacitor 502, 503, 504.

Example 20 provides a DEE array shaped for purpose of “tilling” of multiple array of DEE over principal surface of shaped piece of dielectric material. For example array on FIG. 1-3 may be selected to suit the density and/or scalability of multiple array “tilling” needs of a particular application.

Example 21 provides an array of DEE and/or CPW element formed over various optical and fiber optical element including lenses, mirror, filters, windows, optical flats, prisms, polarizers, beamsplitters, wave plates, fiber optics and the like.

Example 22 provides a DEE and/or CPW element array having one ore more inductor element. In order to increase inductance inductor element may been sandwiched by adjacent elongated conducting structures coupled to ground plane or to reference potential path.

The examples and preferred embodiments in this specification should not be construed to limit the present invention to only the explicitly just described systems, apparatuses and applications. Those skilled in the relevant art will recognize a methods and techniques for forming an array of DEE and CPW element described above as the systems, apparatuses and applications.

The aspects of the present systems, methods and apparatuses can be modified, if necessary, to employ systems, methods, techniques, apparatuses and concepts of the various patents, applications and publications to provide yet further embodiments of the present methods and systems. Further, the invention is applicable to other embodiments or of being practiced or carried out in various ways. For example, current enclosure should be understood to support an applications with any number of the disclosed distributed elements, with each element alone, and also with any and all various permutations, and combinations of all elements in this or any subsequent application. Furthermore, those of skill in the art will appreciate that, the actions recited in the claims can be performed in a different order and still achieve desirable results.

It is to be appreciated that the concepts, systems, circuits, methods and techniques of current disclosure sought to be protected herein are not limited to use in a particular application. In contrast, the concepts, systems, circuits, techniques and methods may be found useful in substantially any application where a manufacturer desires to fabricate arrays of DEE and/or CPW element.

### PATENT CITATIONS (5)

Jerry M. Chow et al, International Business Machines Corp. Modular array of vertically integrated superconducting qubit devices for scalable quantum computing. United States U.S. Pat. No. 10,304,005B2, 2019 May 28.
Oleksandr Chernyashevskyy, Signal and Ground Conductor Inlay. United States U.S. Ser. No. 29/875,561, 2023 May 6.
Alfred Zenne, Oxxel Oxide Electronics Tech GMBH. Josephson junction array device, and manufacture thereof. United States U.S. Pat. No. 6,348,699B1, 2002 Feb. 19.
John A. Rogers, Hian Huang, University of Illinois. Biodegradable materials for multilayer transient printed circuit boards. United States U.S. Pat. No. 10,292,263B2, 2016 Feb. 18.
Antonio D. Corcoles Gonzales, Jiasing Gao, Dusting A. Hite et al, Government of United States, COMMERCE NATIONAL INSTITUTE OF STANDARDS AND TECHNOLOGY, Secretary of, International Business Machines Corp, National Institute of Standards and Technology (NIST). Low loss superconducting devices. United States U.S. Pat. No. 6,348,699B1, 2015 Feb. 10.
James Sor, Y Qian, T Iton, IEEE Trans. Microwave Theory and Tech., Vol. 49, No12, pp 2336-2341 December 2001.

What is claimed is:

1. A scalable array of a distributed elongated elements (DEE) comprising:
a shaped piece of dielectric material having thermal conductivity above a defined threshold and having at least one principal surface; and
a plurality of the DEE having first and second end disposed over at least a portion of one or more principal surface of shaped piece of dielectric material;
wherein the DEE do not cross each other; and each of the plurality of DEE separated from adjacent DEE by a respective elongated gap.

2. A scalable array of a coplanar waveguide (CPW) elements comprising:
a shaped piece of dielectric material having thermal conductivity above a defined threshold and having at least one principal surface; and
a plurality of CPW elements further comprising a plurality of signal elements having first and second end, and a plurality of elongated ground structure disposed over at least a portion of at least one principal surface of the shaped piece of dielectric material; wherein
the CPW signal elements do not cross each other and adjacent ground plane structure; and
each of the plurality of CPW signal element separated from the adjacent elongated ground structure by a respective elongated gap.

3. The array according to claim 1 or 2, further comprising at least one a ground plane disposed over at least a portion of the principal surface of the shaped piece of dielectric material; and
a first dielectric layer laminated over at least one ground plane; and
one or more element or structure selected from the group comprising the DEE, CPW element, CPW ground structure and combination thereof disposed over the first dielectric layer; wherein
each element or structure selected from the group comprising DEE element, CPW signal element, CPW ground structure and combination thereof do not cross each other; and
each element or structure separated from adjacent element or structure by a respective elongated gap.

4. The array according to claim 1 or 2 wherein one or more elongated element or structure selected from the group comprising the DEE, CPW signal element, CPW ground structure and combination thereof formed to have non-uniform or different dimensions.

5. The array according to claim 1 or 2, further comprising one or more lumped electronic element communicatively coupled to one or more array element or structure selected from the group comprising the DEE first end, DEE second end, CPW element first end, CPW element second end and combination thereof.

6. The array according to claim 1 or 2 further comprising one or more lumped electronic element disposed over one or more principal surface of the shaped piece of dielectric material; and
at least one cascade further comprising multiple element selected from the group comprising the DEE, CPW element and combination thereof communicatively coupled in series by one or more lumped electronic element; wherein
the cascades do not cross each other and adjacent elements or structures; and
each cascade separated from adjacent cascade and DEE by a respective elongated gap.

7. The array according to claim 1 or 2, further comprising one or more elongated portions of one or more principal surface of the shaped piece of dielectric material or the first dielectric layer that are elevated or recessed with respect to adjacent portions of the principal surface or the first dielectric layer;
wherein one or more array element or structure selected from the group comprising the DEE, CPW element and combination thereof disposed along the elongated elevated or recessed portions of the principal surface of the shaped piece of dielectric material or the first dielectric layer.

8. The array according to claim 1 or 2, wherein one or more array element selected from the group comprising the DEE first end, DEE second end, CPW element first end, CPW element second end and combination thereof terminated with a common ground plane or with a reference potential plane.

9. A method for forming a scalable array of a distributed elongated elements (DEE) comprising the steps of:
providing a shaped piece of dielectric material having thermal conductivity above a defined threshold, and having one or more principal surface; and
disposing a plurality of the DEE having first and second end over at least a portion of one or more principal surface of the shaped piece of dielectric material in such a manner that each of the plurality of DEE do not cross adjacent DEE; and
separating adjacent DEE by a respective elongated gap.

10. A method for forming a scalable array of a coplanar waveguide (CPW) elements comprising steps of:
providing a shaped piece of dielectric material having one or more principal surface; and
disposing a plurality of a CPW signal elements and a plurality of elongated ground structure over at least a portion of one or more principal surface of the shaped piece of dielectric material; and
configuring and arranging ground plane structure thereon in form of elongated stripes; and
configuring each of the plurality of CPW signal elements and adjacent elongated ground structure in such a manner that the signal elements and elongated ground structures do not cross each other;
and the adjacent signal elements and elongated ground structures are separated by a respective elongated gap; and
disposing one or more lumped electronic element over one or more principal surface of the shaped piece of dielectric material; and
communicatively coupling one or more lumped electronic element to one or more CPW element.

11. The method for forming the array according to claim 9 or 10, further comprising steps of:
disposing one or more ground plane over at least a portion of the one or more principal surface of the shaped piece of dielectric material; and
laminating a first dielectric layer over the common ground plane; and
disposing one or more element selected from the group comprising the DEE, CPW element and combination thereof over at least a portion of the first dielectric layer;
configuring each of the plurality of DEE, CPW signal elements or adjacent elongated ground structures in such a manner that each element or structure selected from the group comprising DEE element, CPW signal element, CPW ground structure and combination thereof do not cross each other; and
separating each element or structure from adjacent element or structure by a respective elongated gap.

12. The method for forming the array according to claim 9 or 10, further comprising step of forming one or more element selected from the group comprising DEE element, CPW element and combination thereof to have non-uniform or different dimensions.

13. The method for forming the scalable array according to claim 9 or 10, further comprising steps of of disposing one or more lumped electronic element over the principal surface of the shaped piece of dielectric material; and communicatively coupling one or more lumped electronic element to one or more array element end selected from the group comprising the DEE first end, DEE second end, CPW element first end, CPW element second end and combination thereof.

14. The method for forming the array according to claim 9 or 10, further comprising step of providing one or more lumped electronic element disposed over over one or more principal surface of the shaped piece of dielectric material; and
forming one or more cascade of DEE or CPW elements; and
coupling in series element selected from the group comprising DEE, CPW element and combination thereof; and
communicatively coupling the respective end of each cascade element by one or more lumped electronic element; and
configuring cascades to do not cross each other and adjacent array element; and
separating each cascade from adjacent DEE and another cascade by a respective elongated gap.

15. The method for forming the array according to claim 9 or 10, further comprising step of forming one or more elongated elevated or recessed portions on the principal surface of the shaped piece of dielectric material or on the first dielectric layer that are elevated or recessed with respect to other portions of the principal surface or first dielectric layer;
disposing one or more array element selected from the group comprising the DEE, CPW element and combination thereof over the elongated elevated or recessed portions of the principal surface of the shaped piece of dielectric material or the first dielectric layer.

16. The method for forming the array according to claim 9 or 10, further comprising step of terminating at least one end of element selected from the group comprising DEE, CPW element, lumped electronic element and combination thereof with common ground plane or with a reference potential plane.
